(19) United States
(12) Patent Application Publication
(10) Pub. No.: US 2004/0218683 A1
(43) Pub. Date: Nov. 4, 2004

(54) Multi-mode wireless devices having reduced-mode receivers

(75) Inventors: Anuj Batra, Dallas, TX (US); Jaiganesh Balakrishnan, Dallas, TX (US); Anand G. Dabak, Plano, TX (US); Srinath Hosur, Plano, TX (US)

Correspondence Address: TEXAS INSTRUMENTS INCORPORATED, P O BOX 655474, M/S 3999, DALLAS, TX, 75265

(73) Assignee: Texas Instruments Incorporated, Dallas, TX

(21) Appl. No.: 10/818,628

(22) Filed: Apr. 6, 2004

Related U.S. Application Data
(60) Provisional application No. 60/466,955, filed on May 1, 2003.

(51) Int. Cl. H04Q 7/24

(52) U.S. Cl. 375/261; 375/222

(57) ABSTRACT

Multi-mode wireless devices having single-mode or reduced-mode receivers. In one embodiment, a wireless device is provided with a transmitter and a receiver. The transmitter transmits with any one of multiple selectable modulation techniques, the selected modulation technique being selected to correspond to a modulation technique supported by a target wireless device. The receiver receives signals modulated in accordance any one of a subset of the selectable modulation techniques. The subset might include only one modulation technique. Also disclosed is a wireless communications method in a wireless device having a transmitter configurable to transmit in at least one modulation mode other than that receivable by the wireless device.

### PRIORITY CLAIM

This application claims priority to U.S. Patent Application Ser. No. 60/466,955, filed on May 1, 2003, entitled “DUAL MODE-ULTRA-WIDEBAND DEVICES,” incorporated herein by reference.

### BACKGROUND

A network is a system that allows communication between members of the network. Wireless networks allow such communications without the physical constraints of cables and connectors. Recently, wireless local area networks (a local area network is a computer network covering a local area such as an office or a home) with ranges of about 100 meters or so have become popular. Wireless local area networks are generally tailored for use by computers, and as a consequence such networks provide fairly sophisticated protocols for establishing and maintaining communication links. Such networks, while useful, may be unsuitably complex and too power-hungry for electronic devices of the future.

A wireless personal area network is a network with a more limited range of about 10 meters or so. With the more limited range, such networks may have fewer members and require less power than local area networks. The IEEE (Institute of Electrical and Electronics Engineers) is developing a standard for wireless personal area networks. The IEEE 802.15.3 standard specifies a wireless personal area medium access control (MAC) protocol and a physical (PHY) layer that may offer low-power and low-cost communications with a data rate comparable to that of a wireless local area network. The standard coins the term “piconet” for a wireless personal area network having an ad hoc topology of devices coordinated by a piconet coordinator (PNC). Piconets form, reform, and abate spontaneously as various electronic devices enter and leave each other's proximity. Piconets may be characterized by their limited temporal and spatial extent. Physically adjacent devices may group themselves into multiple piconets running simultaneously.

The IEEE 802.15.3a task group is developing a new PHY layer operating in an ultra wide band (UWB) and providing very high data rates (in excess of 100 Mbps). Multiple signaling techniques have been proposed for the exploitation of the bandwidth made available for UWB devices, including multi-band OFDM (Orthogonal Frequency Division Multiplexing), pulsed multi-band, and pulsed wide band, wideband MBOK (Mary bi-orthogonal keying), and DS-CDMA (direct sequence code division multiple access).

The multi-band OFDM technique divides the available bandwidth into multiple frequency bands of approximately 500 MHz each. Communication takes place in the form of OFDM symbols, which are multi-sample symbols that carry data on multiple, equally-spaced, carrier frequencies. OFDM symbols are typically constructed by first expressing data bits as amplitudes of frequency components for a symbol period. An inverse Fourier Transform is then used to convert the frequency components into a time-domain signal. This time domain signal, often with a cyclic or zero-padded prefix added, forms the OFDM symbol which is then frequency-shifted to the desired frequency band. Communication takes place on each band in turn, i.e., in an interleaved fashion.

The pulsed multi-band technique, like the multi-band OFDM technique, divides the available bandwidth into multiple frequency bands of approximately 500 MHz each. Communication takes place in the form of shaped QPSK pulses. QPSK stands for quadrature phase shift keying, and commonly indicates the superposition of an in-phase carrier signal having one of two possible phases (i.e., zero or 180°) with a quadrature carrier signal also having one of two possible phases. The carriers are limited to very short pulses (less than about four nanoseconds). The pulse envelopes are then shaped. One example of shaping is a “rectified cosine”, i.e., in the shape of a positive half-period of a sinusoid. The carrier pulses are then shifted to the desired frequency band. Again, communication takes place on each band in turn.

The pulsed wide-band technique does not subdivide the available bandwidth into multiple frequency bands. Rather, communication takes place over a single wide band using shaped BPSK or QPSK pulses. In the case of pulsed wide-band, the carrier pulses are limited to about a nanosecond. As before, the carrier pulses are shaped and shifted to the desired frequency.

The CDMA and wideband MBOK techniques also employ a single large frequency band. Communication takes place in the form of modulated codewords. Each network has one of a set of orthogonal codewords, which are expressed in terms of very brief “chips”, i.e., each codeword provides transitions at a much higher frequency than the data. The data is expressed as an amplitude value for modulating the codeword. The modulated codeword is then shifted to the desired frequency.

The various proposed techniques offer various tradeoffs between performance and cost. It would be desirable to provide a method of supporting multiple communication techniques in a single, compatible system.

### SUMMARY

Accordingly, there is disclosed herein multi-mode wireless devices having single-mode or reduced-mode receivers. In one embodiment, a wireless device is provided with a transmitter and a receiver. The transmitter transmits with any one of multiple selectable modulation techniques, the selected modulation technique being selected to correspond to a modulation technique supported by a target receiving wireless device. The receiver receives signals modulated in accordance any one of a subset of the selectable modulation techniques. The subset might include only one modulation technique.

Also disclosed is a wireless communications method in a wireless device having a transmitter configurable to transmit in at least one modulation mode other than that receivable by the wireless device. The method includes: ascertaining a modulation mode receivable by a target device; presenting capability information indicative of a modulation mode receivable by a wireless device; configuring the transmitter to transmit in the modulation mode receivable by the target device; and transmitting data to the target device.

### BRIEF DESCRIPTION OF THE DRAWINGS

A better understanding of the present invention can be obtained when the following detailed description is considered in conjunction with the following drawings, in which:

FIG. 1 shows a piconet having multiple devices;

FIG. 2 shows a technique for supporting multiple communications modes in a single piconet;

FIG. 3 shows an illustrative wireless device;

FIG. 4 shows a block diagram of an illustrative multi-mode transmitter;

FIG. 5 shows a block diagram of an alternative multi-mode transmitter;

FIGS. 6A-6F show an illustrative framing structure for piconet communications; and

FIG. 7 shows examples of wireless devices having different combinations of transmission and receive modes.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION

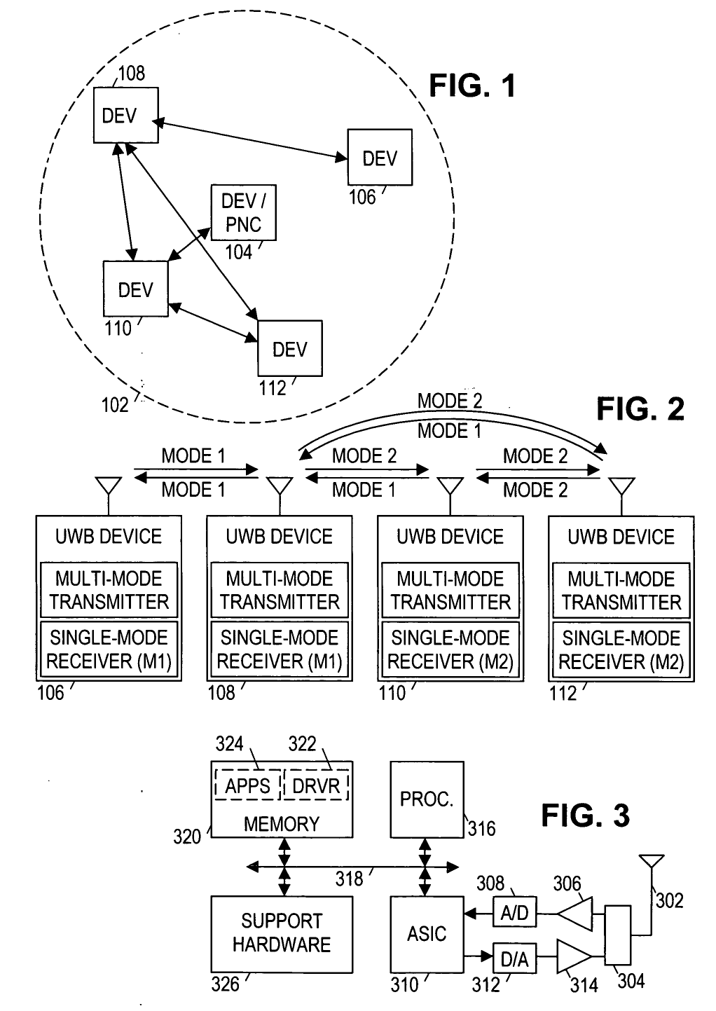

FIG. 1 shows a number of electronic devices that have cooperated to form an illustrative piconet 102. Piconets have an ad hoc topology that results from the spontaneous combinations of devices that are in close proximity. Devices 104-112 are members of piconet 102. Some or all of the devices that can participate in piconet communications can also operate as the piconet coordinator (“PNC”). In FIG. 1, device 104 is operating as the PNC for piconet 102. PNC device 104 broadcasts beacon frames to facilitate the communications of all members of the piconet. The effective range of the beacon frames (and hence the effective boundary of the piconet) is shown by broken line 102.

Piconet 102 supports multiple communications modes. Each of the devices 104-112 are multi-mode wireless devices having single mode or reduced-mode receivers, i.e., each device can receive only a subset of the communications modes that the device can transmit. Each device includes a transmitter capable of transmitting in each of multiple supported modes. Communications sent to a given device are transmitted in a mode accepted by that device. Because the bulk of the cost and complexity of the transmitter/receiver design is in the receiver, this architecture may allow manufacturers to design compatible devices having different price/performance tradeoffs.

FIG. 2 shows illustrative communications between member devices 106-112 of piconet 102. (The PNC 104 is excluded from FIG. 2, but operates on the same principle when partaking in inter-device communications.) As shown in FIG. 2, each device 106-112 includes a multi-mode transmitter. Devices 106-108 include single mode receivers that receive mode 1 communications, while devices 110-112 include single mode receivers that receive mode 2 communications. Thus, for example, device 108 transmits in mode 1 when communicating with device 106, and transmits in mode 2 when communicating with devices 110 or 112. All communications to device 108 are sent in mode 1. As another example, device 112 transmits in mode 1 when communicating with device 108, and transmits in mode 2 when communicating with device 110. All communications to device 112 are sent in mode 2. More than two modes may be supported.

To become a member of a piconet, each device must register with the PNC 104. As part of the registration, the device may inform the PNC 104 of the device's capabilities, including the transmit mode to be used when communicating with the device. The PNC 104 incorporates the capability information in the beacon frames to inform all the other members of the presence and capability of the new device. In this manner, each device may be informed of the appropriate transmit mode for communicating with a given device. Because of relative motion between the various devices, piconet membership may be subject to constant change. Accordingly, it may be desirable for the PNC 104 to conduct periodic polling and re-determination of device membership and device capability.

FIG. 3 shows a block diagram of an illustrative piconet member device. Piconet frames are transmitted and received via an antenna 302. (At the frequencies of interest, the antenna may be implemented as a trace on a printed-circuit card.) A switch 304 couples the antenna 302 to an amplifier 306 during receive periods. The amplifier 306 may be followed by filter and frequency down-conversion circuitry (not specifically shown). An analog to digital converter 308 converts the receive signal into digital form for processing by an application specific integrated circuit (ASIC) or some other form of digital processor 310. The digital processor 310 may be implemented by hardware, firmware, or a combination thereof. It performs demodulation and decoding of the receive signal to obtain receive data, and may further perform modulation and encoding of transmit data to produce a digital transmit signal. A digital to analog converter 312 converts the digital transmit signal to an analog transmit signal, which is amplified by driver 314 and provided by switch 304 to antenna 302 during transmit periods. Frequency up-conversion and filter circuitry may be provided between the digital-to-analog converter 312 and the driver 314.

Digital processor 310 may interface with a microprocessor 316 to handle higher level functionality such as media access control (MAC) protocol, application software, and user interaction. A bus 318 may couple together the digital processor 310, the microprocessor 316, a memory 320, and other support hardware 326. The microprocessor 316 operates in accordance with software stored in memory 320. (The term “software” is intended to include firmware and processor instructions of any other type.) The software may include device drivers 322 to facilitate the communications between applications 324 and the digital processor 310. The microprocessor 316 may interact with such support hardware 326 as a keyboard, keypad, buttons, dials, a pointing device, a touch sensitive screen, an alphanumeric or graphics display, lights, a printer, speakers, a microphone, a camera, and/or other mechanisms for interfacing with a device user. Alternatively, or in addition, the support hardware may include nonvolatile information storage, a network interface, a modem, a sound card, a radio/television tuner, a cable/satellite receiver, or other electronic modules helpful to the device's purpose.

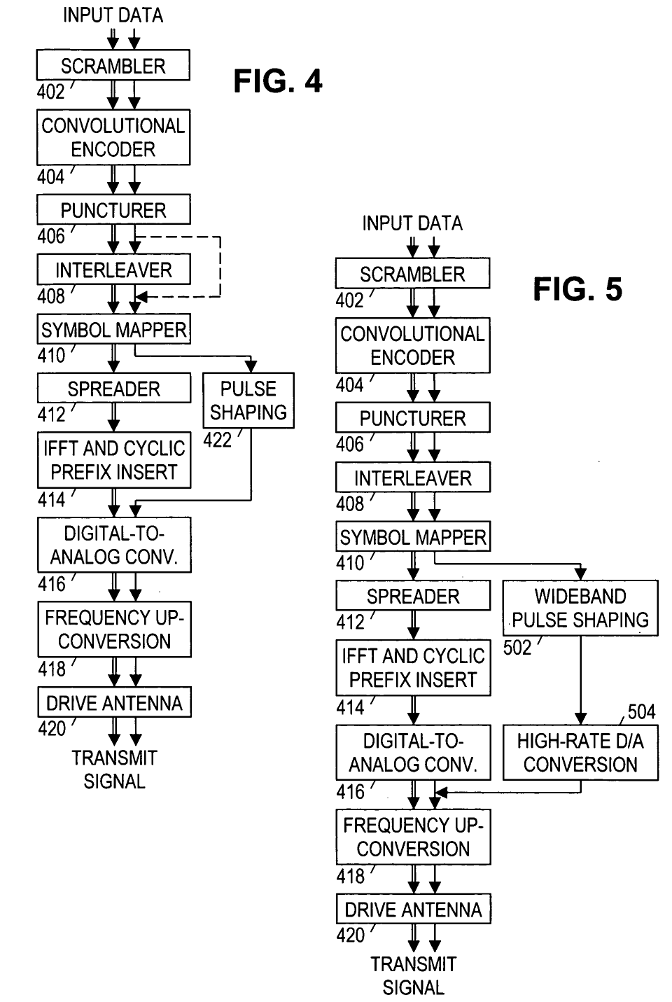

FIG. 4 shows a block diagram of an illustrative multi-mode transmitter which may be implemented by digital processor 310. The various blocks are coupled in one of two potential sequences. One sequence is shown using double-line arrows, while the other sequence is shown using single-line arrows. Most of the blocks are shared by both sequences, making a multi-mode transmitter fairly easy to implement. In the illustrative transmitter of FIG. 4, the double-line arrow sequence is used for orthogonal frequency division multiplexing (OFDM) multi-band transmissions, while the single-line arrow sequence is used for pulsed multi-band transmissions.

The OFDM multi-band transmission sequence begins with block 402, where a stream of input data is “scrambled”. The scrambling operation is typically implemented by a bit-wise exclusive-or operation combining the input data stream with a pseudo-random bit stream. The scrambling operation reduces the probability of patterns in the data which might invalidate assumptions underlying the performance analysis of subsequent coding and modulation operations. In block 404, an error correction code (ECC) encoder adds redundancy to the scrambled bit stream to provide resistance against detection errors. FIG. 4 identifies the ECC encoder as a convolutional encoder, but other ECCs may also be suitable.

In block 406 an optional puncturer drops some of the redundant information added by the ECC encoder. The puncturer allows the code rate (i.e., the ratio between the number of input symbols to the encoder to the number of output symbols from the encoder) to be tailored at some cost to the error resistance. Thus, for example, a rate ⅓ binary ECC code (i.e., 3 code bits for every input bit) may be converted to an 11/32 binary ECC code, which may allow for more efficient manipulation in a system that works with 32-bit words. As another example, a rate ⅓ binary code may be converted to a ⅔ rate when the device operates in environments having higher signal to noise ratios.

In block 408, an interleaver rearranges bits from the encoded bit stream to disperse adjacent bits. In one implementation, the interleaver may write the incoming bitstream into a matrix row-by-row, and form the interleaved bit stream by reading out of the matrix column by column. This operation may be reversed at the receiver, with the beneficial effect that any bursts of detection errors will be dispersed and made to appear as single isolated errors that are more easily handled by the ECC code.

In block 410, a symbol mapper breaks the interleaved bit stream into symbols, associating multiple bits with each symbol The number of bits associated with each symbol depends in part on the modulation technique, but may also depend on the quality of the communications channel over which the data is being transmitted. The symbol mapper 410 may also group the symbols into frames and provide a standard-compliant preamble (and perhaps a standard-compliant trailer) to each frame. These additions may facilitate timing acquisition and data extraction at the receiver.

In block 412, a spreader distributes the data bits among the various frequency coefficients for the OFDM symbol. The distribution is typically determined from measurements of the communications channel signal-to-noise ratio at different frequencies. In block 414, an inverse Fourier Transform is applied to the frequency coefficients to obtain a (digital) time domain symbol. A cyclic prefix or a zero-padded prefix may be added to the time domain symbol to reduce intersymbol interference.

In block 416, a digital-to-analog converter converts the sequence of digital symbols into an analog (low-frequency) signal. In block 418, the analog signal may be amplified, combined with a high-frequency carrier, and filtered, thereby shifting the analog signal from the low-frequency band to a high-frequency band. The high-frequency carrier may be changed from symbol-to-symbol to provide time-frequency interleaving. In block 420, an antenna driver provides the high-frequency signal as a transmit signal to an antenna.

The pulsed multi-band transmission sequence generally parallels the OFDM multi-band sequence, with the following differences. The interleaver 408 is optional, and may be bypassed. The symbol mapper 410 produces a symbol stream with fewer bits per symbol. The spreader block 412 and inverse Fourier Transform block 414 are replaced by a pulse-shaping block 422. The pulse shaping block converts the bits for each symbol into an in-phase and quadrature phase signal amplitude. The shaping block then generates a shaped carrier pulse having the appropriate in-phase and quadrature phase signal components. A shaped carrier pulse is generated for each symbol. The sequence of shaped carrier pulses is provided to the analog-to-digital converter block 416 for conversion to a low-frequency analog signal.

FIG. 5 shows a block diagram of another illustrative multi-mode transmitter which may be implemented by digital processor 310. Like the transmitter of FIG. 4, the transmitter of FIG. 5 includes a double-line arrow sequence for OFDM multi-band transmission. However, the single-line arrow sequence may be used for pulsed wide band transmission. Pulse shaping block 422 is replaced by a wideband pulse shaping block 502, which generates much shorter pulses to represent symbols. The symbol stream from pulse shaping block 502 is provided to a high-rate digital to analog converter 504, which converts the symbol stream into a (wideband) low frequency analog signal. In an alternative embodiment, digital-to-analog converter 416 may be configurable to operate at different conversion rates to produce both the OFDM low frequency signal and the pulsed wideband low frequency signal. In both embodiments, the wideband low-frequency analog signal is frequency shifted by frequency up-conversion block 418.

In another alternative embodiment, the wideband pulse shaping block 502 may be replaced with a code word modulation block, thereby allowing the transmitter to provide CDMA transmissions. In yet another alternative embodiment, the transmitter may support more than two transmission modes. In still yet another embodiment, frequency up-conversion may be performed in the digital domain, e.g., as part of a pulse shaping operation. The foregoing examples are meant to be illustrative and not limiting.

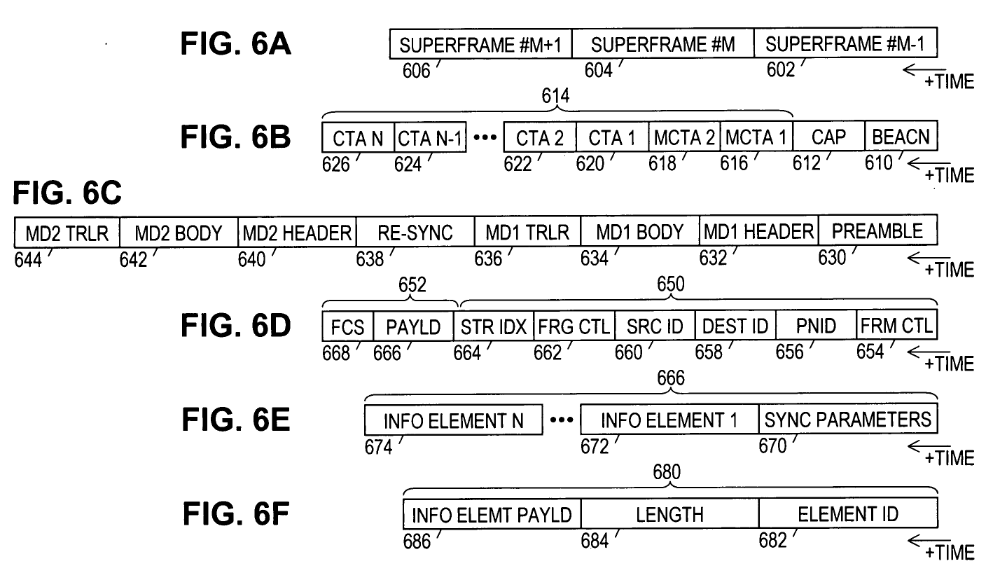

FIGS. 6A-6F show an illustrative framing structure. In each of these figures, the time axis increases from right to left, so that the rightmost portion of the figure corresponds to the earliest portion of the communications sequence, and the leftmost portion corresponds to the latest portion of the sequence. The figures are not to scale.

FIG. 6A shows a sequence of superframes that includes superframes 602, 604, and 606, which occur in order from right to left. As shown in FIG. 6B, each superframe begins with a beacon frame 610, which is transmitted by the PNC. The beacon 610 is followed by an optional contention access period (“CAP”) 612. During the CAP, the piconet member devices may attempt communications using a CSMA/CA protocol. The optional CAP 612 is followed by a channel time allocation period (“CTAP”) 614, which is composed of channel time allocations (“CTAs”) 616-626. Any of the CTAs in the channel time allocation period 614 may be management CTAs (“MCTAs”) (e.g., MCTAs 616, 618). CTAs are allocated for communications from a specified source device to a specified destination device or a group of destination devices. The length of the CAP and the allocations of the CTAs are specified in the beacon frame.

The member devices may request channel time allocations by sending management frames to the PNC. Depending on parameters specified by the beacon, the management frames may be sent during the CAP or during MCTAs. Similarly, data frames may be exchanged by member devices during the CAP or CTAs.

FIG. 6C shows an illustrative beacon format. The beacon may be used to allocate channel times and provide all member devices with information regarding the existence and capabilities of other member devices. To allow the various member devices having different single-mode or reduced-mode receivers to obtain the beacon information, the beacon information may be sent in multiple modes. The beacon of FIG. 6C includes a preamble 630, a mode 1 header 632, a mode 1 body 634, a mode 1 trailer 636, a re-synchronization field 638, a mode 2 header 640, a mode 2 body 642, and a mode 2 trailer 644.

Preamble 630 may be a predefined, standard sequence that is designed to provide packet detection, frame synchronization, and a training pattern for estimating the channel properties. To that end, the preamble 630 may begin with a detection field having a very narrow autocorrelation peak to allow a receiver to detect the beginning of the preamble. The detection field may be followed by a field having sign-reversed symbols to indicate the transition from the detection field to the training pattern. Finally, the predefined training pattern may be used by the receiver to estimate the channel spectrum.

The preamble 630 is followed by a physical (PHY) layer frame header 632, a PHY layer frame body 634, and a PHY layer trailer 636 sent using mode 1. The PHY layer frame header 632 includes a field for indicating a data rate of the PHY layer frame body 634, a field for indicating a length of the PHY layer frame body, and a field for indicating the pseudo-random scrambling sequence. The PHY layer frame body 634 includes a media access control (MAC) frame. The PHY layer trailer 636 may be provided when a convolutional ECC encoder is used. The trailer 636 restores a convolutional decoder to an initial state. Alternatively, or additionally, the trailer may include a guard field to allow switching between modulation techniques.

A resynchronization field 638 follows the mode 1 fields 632-636. The resynchronization field 638 may be a predefined, standard sequence that is designed to provide detection of the end of the mode 1 fields and frame synchronization. To that end, the resynchronization field 638 may include a detection field followed by a synchronization field having sign-reversed symbols to indicate the end of the resynchronization field.

The resynchronization field 638 is followed by a PHY layer frame header 640, a PHY layer frame body 642, and a PHY layer trailer 644, this time sent using mode 2. These fields carry the same information as before, but in a different transmission mode. In one embodiment, OFDM multi-band is used for mode 1, and pulsed multi-band is used for mode 2. In another embodiment, OFDM multi-band is used for mode 2, and wide-band MBOK is used for mode 1. In both embodiments, both mode 1 and mode 2 receivers may detect the preamble and use the training pattern to estimate the channel. The mode 1 receivers then extract beacon data from fields 632-636 while the mode 2 receivers scan for the resynchronization field 638. Thereafter, the mode 1 receivers can estimate the end of the beacon and wait. The mode 2 receivers detect the resynchronization field 638 and extract beacon data from fields 640-644.

In the illustrative beacon of FIG. 6C, the beacon information is encoded in two modes. In alternative embodiments, the beacon format may include alternative or additional modes to ensure that all receiving devices can decode the beacon information. For example, the beacon format may include alternative or additional header/body/trailer sequences separated by resynchronization fields. In one implementation, the header/body/trailer sequences may be provided in some combination of the following modes: multi-band OFDM, 802.11g, wideband MBOK, DS-CDMA, Bluetooth, 802.15.3a, and pulsed multi-band.

FIG. 6D shows a MAC frame format which appears in the PHY layer frame bodies 634 and 642 of the beacon, and appears in the PHY layer frame body of all other frames sent during the superframe (including any mangement frames, data frames, and acknowledgment frames). Each frame includes a medium access control (“MAC”) header 650, and a MAC frame body 652. Each is described in turn below.

The MAC header 650 includes a frame control field 654, a piconet identifier field 656, a destination identifier field 658, a source identifier field 660, a fragmentation control field 662, and a stream index field 664. The frame control field 654 may include a field that specifies the protocol version, a field that specifies the frame type (e.g., beacon, data, acknowledgment), a field that specifies whether the frame is security protected, a field that indicates the acknowledgment policy (e.g., none, immediate, delayed), a field that indicates whether the frame is a “retry” (i.e., a re-transmission of an earlier frame), and a field that indicates whether additional frames from the source will follow in the current CTA. The piconet identifier field 656 specifies a unique 16-bit identifier for the piconet. The destination identifier field 658 specifies an 8-bit piconet member device identifier for the device to which the frame is directed (special values may be used for broadcast or multicast frames). Similarly, the source identifier field 660 specifies the 8-bit piconet member device identifier for the device which is transmitting the frame. The fragmentation control field 662 includes fields that are used for reconstructing large data units that have been split into fragments small enough to be sent in MAC frames. The fragmentation control field 662 may include a field specifying a data unit number, a field specifying the current fragment number, and a field specifying the total number of fragments in the data unit. The stream index field 664 may specify a stream identifier for isochronous streams (which produces data in a periodic fashion) and asynchronous traffic (which may arrive for transfer any time).

The MAC frame body 652 includes a payload field 666, and a frame check sum field 668. The payload field 666 is a variable length field that carries the information that is to be transferred. Finally, the frame check sum field 668 contains a 32-bit cyclic redundancy code (“CRC”) value that is calculated over the entire payload field 666. Corruption of the payload may be detected by comparing the frame check sum field value to a CRC value calculated over the received payload field by the MAC functionality of the receiver.

FIG. 6E shows the payload field 666 for a beacon frame. The beacon frame payload field 666 includes a piconet synchronization parameters field 670, and one or more information element fields 672, 674. The piconet synchronization parameters field 670 may include a field that specifies a time token (a 48-bit rollover counter that increments for each beacon), a field that specifies the duration of the superframe, a field that specifies the end of the contention access period, a field that specifies a maximum transmit power for piconet member devices, a field that specifies the piconet mode, a field that specifies the PNC response time, and a field that specifies the 8-byte device address for the PNC.

The information element fields 672-674 may be used to provide various piconet events and parameters including: PNC capabilities, a list of piconet member devices and their capabilities (including the transmission mode for communicating with each device), a list of channel time allocations, CTA properties, device wake-up requests, shutdown notifications, piconet parameter changes, PNC handovers, transmit power control values, and identifiers of overlapping piconets. FIG. 6F shows the structure of a generic information element 680. Every information element includes an element identifier field 682 that specifies the information element type (e.g., a list of channel time allocations), a length field 684 that specifies the length of the information element payload field in bytes, and an information element payload field 688 that contains information in a format specific to the information element type.

A new information element, the “modulation mode” information element, may be defined to specify the modulation mode receivable by each of the piconet members. Assuming there are only two modulation modes supported, and assuming that there are a maximum of 256 members allowed in the piconet, the modulation mode information element may be 256 bits long (one bit for each of the possible members). Thus the information element payload would be 32 bytes long.

One variation on the disclosed embodiments would be to limit the beacon frame to fields 630-636, and to send alternate beacons using different modulation modes (or rotating through the modes systematically when more than two modulation modes are used). For example, the first beacon could use OFDM multi-band, the second could use pulsed multi-band, the third could use OFDM multi-band, and so on. This variation may allow for dynamic allocation of the length of each superframe in accordance with the number of devices that receive in each mode. For example, if there are more receivers for OFDM multi-band than for pulsed multi-band, the superframes for OFDM multi-band communications may be longer, and vice versa.

Rather than strictly alternating between modulation modes, another variation of the disclosed embodiments would provide a certain number of superframes for transmissions in the first mode, followed by a certain number of superframes for transmissions in the second mode. This principle can be extended to more than two modes. The numbers can be dynamically adjusted depending on the make-up of the piconet and the traffic load each device needs to support. For example, if OFDM multi-band receivers have a very high traffic load and pulsed multi-band receivers have a low, bursty traffic load, then it makes sense to provide multiple superframes for OFDM multi-band communications followed by a single superframe for pulsed multi-band communications.

Yet another variation would involve dividing each superframe into two or more parts, one part for each modulation mode. For example: one part for OFDM multi-band communications, and another part for pulsed multi-band communications. Again, the length of each part could be dynamically allocated in order to be fair to all devices and to ensure maximum throughput for the piconet. The same partitioning approach could be used for the contention access period, e.g., the first part could be used for OFDM multi-band, while the second part could be used for pulsed multi-band.

Various ultra wide band (UWB) protocols have been described as context for the foregoing disclosure. However, the illustrative wireless devices may alternatively or additionally implement other wireless communication protocols including without limitation 802.11 and Bluetooth protocols.

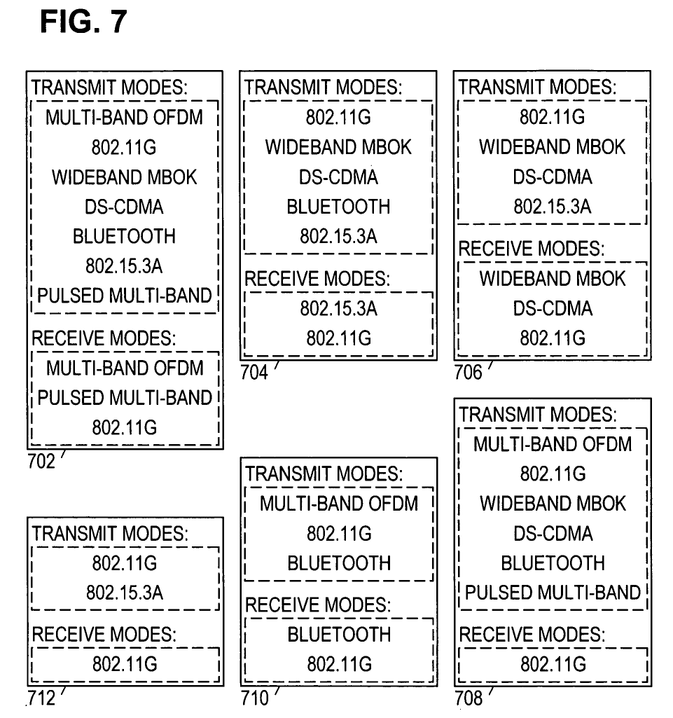

FIG. 7 shows various illustrative wireless devices having different combinations of transmit and receive mode functionality. In each example, the device receives a subset of the protocols that the device can transmit. Device 702 supports multi-band OFDM, 802.11g, wideband MBOK, DS-CDMA, Bluetooth, 802.15.3a, and pulsed multi-band transmit protocols, but only receives multi-band OFDM, pulsed multi-band, and 802.11g protocols. Device 704 supports 802.11g, wideband MBOK, DS-CDMA, Bluetooth, and 802.15.3a transmit protocols, but only receives 802.15.3a and 802.11g protocols. Device 706 supports 802.11g, wideband MBOK, DS-CDMA, and 802.15.3a transmit protocols, but only receives wideband MBOK, DS-CDMA, and 802.11g protocols. Device 708 supports multi-band OFDM, 802.11g, wideband MBOK, DS-CDMA, Bluetooth, and pulsed multi-band transmit protocols, but only receives the 802.11g protocol. Device 710 supports multi-band OFDM, 802.11g, and Bluetooth transmit protocols, but only receives Bluetooth and 802.11g protocols. Device 712 supports 802.11g and 802.15.3a transmit protocols, but only receives the 802.11g protocol.

Each of the devices in this example shares the ability to receive 802.11g, allowing each of the devices to receive and recognize information in 802.11g beacon frames, and to perhaps participate in the 802.11 channel time allocation procedure. For inter-device communications with other devices that support other protocols that may be more desirable than 802.11 (e.g., for low latency, high data rates, or quality control reasons), these other protocols may be employed. For example, device 702 may transmit to device 710 using a Bluetooth protocol, and may receive communications from device 710 in accordance with the multi-band OFDM protocol.

Although specific 802.11 standards and specific Bluetooth specifications may have been cited as examples in the foregoing description, it should be recognized that any member of the 802.11 family or the Bluetooth family could be used. As used herein, the term “802.11 family” includes the following standards: 802.11, 802.11a, 802.11b, 802.11g, and future 802.11 standards (e.g., 802.11n). The term Bluetooth family includes the following specifications: Bluetooth 1.0, Bluetooth 1.0b, Bluetooth 1.1, Bluetooth 1.2, and future versions of the Bluetooth specification.

Numerous other variations and modifications will become apparent to those skilled in the art once the above disclosure is fully appreciated. For example, the foregoing methods may be employed in a repeater device. Repeaters receive, demodulate, decode, re-encode, modulate, and re-transmit beacons and other signals to extend the reach of the piconet. Such repeaters may possess reduced-mode receivers and may be configured to provide protocol translations when acting as a bridge between distant devices. Further, in some embodiments the repeaters may be configured to create and transmit multi-mode beacons. It is intended that the following claims be interpreted to embrace all such variations and modifications.

What is claimed is:

1. A wireless device that comprises:
a transmitter configured to transmit with a selected modulation technique from a set of selectable modulation techniques, the selected modulation technique being selected to correspond to a modulation technique supported by a target wireless device; and
a receiver configured to receive a signal modulated in accordance with at least one modulation technique from a subset of the selectable modulation techniques.

2. The wireless device of claim 1, wherein the subset includes only one modulation technique.

3. The wireless device of claim 2, wherein the one modulation technique in the subset is one of orthogonal frequency division multiplexing (OFDM) multi-band signaling, pulsed multi-band signaling, pulsed wide band signaling, code division multiple access (CDMA) signaling, 802.11 family signaling, and Bluetooth family signaling.

4. The wireless device of claim 1, wherein the set of selectable modulation techniques includes orthogonal frequency division multiplexing (OFDM) multi-band signaling.

5. The wireless device of claim 4, wherein the set of selectable modulation techniques includes pulsed multi-band signaling.

6. The wireless device of claim 4, wherein the set of selectable modulation techniques includes pulsed wide-band signaling.

7. The wireless device of claim 4, wherein the set of selectable modulation techniques includes code division multiple access (CDMA) signaling.

8. The wireless device of claim 4, wherein the set of selectable modulation techniques includes 802.11 family signaling.

9. The wireless device of claim 4, wherein the set of selectable modulation techniques includes Bluetooth family signaling.

10. The wireless device of claim 1, wherein the wireless device includes a digital processor that implements digital portions of the transmitter and receiver in compliance with the IEEE 802.15.3a standard.

11. The wireless device of claim 1, wherein the wireless device is configured to cooperate with other wireless devices to form a wireless personal area network.

12. A wireless network that comprises:
a first wireless device having a receiver configured to receive signals modulated in accordance with a first modulation technique; and
a second wireless device having a receiver configured to receive signals modulated in accordance with a second, different modulation technique,
wherein the first wireless device includes a transmitter configured to transmit signals to the second wireless device using the second modulation technique, and
wherein the second wireless device includes a transmitter configured to transmit signals to the first wireless device using the first modulation technique.

13. The wireless network of claim 12, wherein the first and second modulation techniques are different techniques from a set consisting of OFDM multi-band signaling, pulsed multi-band signaling, pulsed wide-band signaling, CDMA signaling, 802.11 signaling, and Bluetooth signaling.

14. The wireless network of claim 12, further comprising:
a third wireless device having a receiver configured to receive signals modulated in accordance with the first modulation technique,
wherein the transmitter of the first wireless device is configured to transmit signals to the third wireless device using the first modulation technique.

15. The wireless network of claim 14, further comprising:
n other wireless devices, 1≦n≦253, each including a transmitter configured to transmit signals to the first wireless device using the first modulation technique and to transmit signals to the second wireless device using the second modulation technique.

16. The wireless network of claim 12, further comprising:
a piconet controller device configured to transmit beacons, wherein each beacon includes beacon information sent in accordance with the first modulation technique, and wherein each beacon includes beacon information sent in accordance with the second modulation technique.

17. The wireless network of claim 16, wherein each beacon further includes beacon information sent in accordance with a third modulation technique.

18. The wireless network of claim 12, further comprising:
a piconet controller device configured to transmit beacons, wherein at least some of the beacons are transmitted in accordance with the first modulation technique, and wherein others of the beacons are sent in accordance with the second modulation technique.

19. The wireless network of claim 16, wherein the modulation of the beacons alternates between the two modulation techniques.

20. The wireless network of claim 12, further comprising:
a piconet controller device configured to transmit beacons, wherein at least some of the beacons are transmitted in accordance with each of three or more modulation techniques.

21. The wireless network of claim 20, wherein the modulation of the beacons cycles systematically through the three or more modulation techniques.

22. A method of wireless communication by a wireless device, the method comprising:
ascertaining a modulation mode receivable by a target device;
presenting capability information indicative of a modulation mode receivable by said wireless device, said wireless device including a transmitter configurable to transmit in at least one modulation mode other than that receivable by said wireless device;
configuring the transmitter to transmit in the modulation mode receivable by the target device; and
transmitting data to the target device.

23. The method of claim 22, further comprising:
receiving an acknowledgement from the target device, wherein the acknowledgement is transmitted in the modulation mode receivable by the wireless device.

24. The method of claim 22, wherein the transmitter is configurable to transmit in at least two different modulation modes from a set consisting of orthogonal frequency division multiplexing (OFDM) multi-band modulation, pulsed multi-band modulation, pulsed wide band modulation, code division multiple access (CDMA) modulation, 802.11 signaling, and Bluetooth signaling.

25. The method of claim 22, further comprising:
ascertaining a modulation mode receivable by a destination device, wherein the modulation mode receivable by the destination device is different from the modulation mode receivable by said target device;
configuring the transmitter to transmit in the modulation mode receivable by the destination device;
transmitting data to the destination device; and
receiving an acknowledgement from the destination device, wherein the acknowledgement is transmitted in the modulation mode receivable by the wireless device.

26. A method of facilitating wireless communications, the method comprising:
receiving registration requests from wireless devices; and
periodically transmitting a beacon, wherein the beacon includes capability information of wireless devices that have transmitted registration requests, wherein the capability information includes for each wireless device a modulation mode receivable by that wireless device.

27. The method of claim 26, wherein the capability information is provided multiple times in each beacon, each time in a different modulation mode.

28. The method of claim 26, wherein the beacons are alternately transmitted in different modulation modes.
